(19) United States
(12) Patent Application Publication
(10) Pub. No.: US 2009/0231595 A1
(43) Pub. Date: Sep. 17, 2009

(54) MOBILE OBJECT POSITION, MOTION AND ATTITUDE DETECTION IN THREE DIMENSION SPACE

(76) Inventor: Michael Petroff, Arcadia, CA (US)

Correspondence Address: KEUSEY, TUTUNJIAN & BITETTO, P.C., 20 CROSSWAYS PARK NORTH, SUITE 210, WOODBURY, NY, 11797, US

(21) Appl. No.: 12/404,754

(22) Filed: Mar. 16, 2009

Related U.S. Application Data
(60) Provisional application No. 61/069,718, filed on Mar. 17, 2008.

(51) Int. Cl. G01B 11/14

(52) U.S. Cl. 356/614

(57) ABSTRACT

The present invention provides a cost effective mobile object position, motion, and pitch and yaw attitude detector, wherein such mobile object is located in three-dimensional space and such detector employs light interaction between a mobile omni-directional light transmitter disposed on the mobile object, and a single stationary distance and direction vector sensing light receiver. The principles of the invention are particularly beneficial in a video game system, wherein the mobile transmitter comprises an omni-directional light element that uniformly radiates a fixed intensity of light across substantially 4 pi steradians of curvature. The stationary receiver detects the directional vector and the distance to the point-of-origin of light emitted by the light element, each with respect to the receiver, and thereby determines the position of the light element relative to the receiver. By virtue of the light element being disposed at one end of an armature held or worn by a player, the pitch and yaw attitude of such armature, or equivalent thereof, affect Y-vector and X-vector positional data, respectively, of the light element as detected by the stationary receiver in the above-described manner. Thus, the position, motion, pitch and yaw of the mobile object are each detected and thereby affect and interact with a video game of the video game system.

### CROSS REFERENCE TO RELATED APPLICATIONS

This application claims priority from U.S. Provisional Patent Application No. 61/069,718 filed on Mar. 17, 2008.

### FIELD OF THE INVENTION

The present invention relates to mobile object position, motion and attitude detection in three-dimensional space. More particularly it relates to object position, motion and attitude detection in a three-dimensional space using light interaction between a mobile light transmitter and single stationary light receiver in a video game system.

2. Background

Experiments have been conducted with video game systems incorporating mobile object position and motion detection within a playing space, in which such mobile object includes, for example, a light gun or sports artifact. In such prior art video game systems, however, the position and motion of the mobile object within the playing space must be detected by at least two widely separated light sensors, each receiving a light source or reflected light beam from the mobile object, and triangulation is required to determine such object position and motion. Such prior art video game systems have substantial limitations and drawbacks, including but not limited to the fact that the at least two widely separated light sensors must be accurately spaced and oriented relative to one another and relative to the video game, which requirements are not “user friendly” in typical home video game environments.

U.S. Pat. No. 6,545,661 by Goschy discloses the detection of the tilt (or pitch) relative to gravity of a light gun operating in video game system, however such Goschy patent does not disclose a method for detecting the critically important yaw or the less important roll attitude of the light gun, and further does not disclose a method for detecting the position and motion of the light gun outside the confines of the space defined by a video monitor associated with the video game system.

In another example, the Nintendo Wii® (Wii is a registered trademark of Nintendo of America, Inc.) video game system comprises tri-axis (X/Y/Z) accelerometers, which are electronically aligned to the direction of gravity, in a hand-held controller or other mobile object, thereby enabling:

(a) detection of tri-axis vectors of acceleration of such mobile object with acceptable accuracy;

(b) mathematically inferred tri-axis vectors of the velocity of the mobile object, however with inherent time-accumulation of inferred velocity inaccuracies that not are typically critical in video game applications;

(c) mathematically inferred tri-axis vectors of the position of the mobile object, however with inherent time-accumulation of inferred position inaccuracies which, unlike inferred velocity inaccuracies, impose significant restrictions on game interaction potentials;

(d) detection of the critically important pitch and less important roll attitude of the mobile object, but with no detection of the critically important yaw attitude of the mobile object.

Nevertheless, such inferred velocity and position enable the above Nintendo video game system to interact with the inferred velocity, inferred position, pitch and roll of the mobile object within three-dimensional space, which in turn enables a level of game interactivity not previously possible with other prior art video game systems. Significant practical limitations of the video game system nevertheless exist, including:

(i) inherently unknown or inaccurate starting-point position, or reference position, of the mobile object (and more generally also the player), which reference position is therefore best presumed by the video game to exist along the viewing axis of, and at a pre-determined distance from, a monitor used in the video game system in order to enable reasonably accurate video game perspectives and interaction albeit based ONLY on the presumed reference position; and

(ii) inability to detect Yaw attitude of the mobile object, which results in non-analogous game interaction to such important factors as the horizontal Aim direction of the mobile object, particularly when the mobile object takes the form of a virtual gun or sword. Each of the above-described drawbacks inherent in the prior art known to the present inventor are resolved by the video game system of the present invention.

### SUMMARY OF THE INVENTION

The present invention provides a cost effective mobile object position, motion, and pitch and yaw attitude detector, wherein the mobile object is located in three-dimensional space and the detector employs light interaction between a mobile omni-directional light transmitter disposed on the mobile object, and a single stationary distance and direction vector sensing light receiver. The principles of the invention are particularly beneficial in a video game system described herein as exemplary embodiments, wherein the mobile transmitter comprises an, omni-directional light element that uniformly emits a fixed intensity of light throughout a space subtending substantially 4 pi steradians of curvature. Such light element is generally disposed on one end of an armature, or equivalent thereof, held by a hand or worn on another body part of a player of the video game system. The stationary receiver detects the directional vector and distance to the light element, each with respect to the receiver, and therefore the position and motion of the light element, relative to the receiver, are determined.

The directional vector is detected by preferably at least two angularly divergent directional vector detectors that are preferably orthogonal to one another, each such detector providing a gradient of light sensitivity as a function of vector angle, and each such distance to the light element is detected by an omni-directional light sensor receiving light from an omni-directional light source and by inverse square ‘law processing. The directional vector detector(s) may comprise, but are not limited to:

(a) a photo detector exhibiting typically 0 to +90 degrees of non-ambiguous (one side of the polar response curve only) light sensitivity as a function of angle relative to the axis of maximum sensitivity of such detector;

(b) two photo detectors having axes of maximum sensitivity that are orthogonal to one another, each such detector exhibiting typically 0 to +180 degrees of non-ambiguous light sensitivity as a function of angle relative to the corresponding axis of maximum sensitivity;

(c) two clusters of photo detectors, each such cluster having axes of maximum sensitivity that are orthogonal to one another, and each such cluster exhibiting typically 0 to +180 degrees of non-ambiguous light sensitivity as a function of angle relative to the corresponding cluster axis of maximum sensitivity;

(d) two photo detectors having axes of maximum sensitivity that are orthogonal to one another, each such detector coupled to the focal point of a lens exhibiting typically 0 to +180 degrees of non-ambiguous light sensitivity as a function of the corresponding axis of maximum sensitivity;

(e) two photo detectors having axes of maximum sensitivity that are orthogonal to one another, each such detector coupled to one end of a curved and progressively attenuating light pipe, each such light pipe exhibiting typically 0 to +180 degrees of non-ambiguous light sensitivity as a function of polar angle about the corresponding detector axis of maximum sensitivity;

(f) at least two photo detectors having axes of maximum sensitivity that are orthogonal to one another, each such detector coupled to one end of a substantially straight and progressively attenuating light pipe, each such light pipe receiving light from an offset pinhole or lens, each such light pipe or lens exhibiting typically 0 to +180 degrees of non-ambiguous light sensitivity as a function of polar angle about the corresponding detector axis of maximum sensitivity; and

(g) two physically separated clusters of photo detectors, such clusters having angles of maximum sensitivity that are orthogonal to one another, each such cluster having a range of sensitivity subtending substantially 4 pi steradians of space, each cluster receiving light firstly from a highly diffusive and preferably hemi-spherically shaped diffusive filter to normalize light sensitivity throughout such space, and each diffusive filter in turn receiving light from a non-diffusive and preferably ‘hemi-spherically shaped density-gradient filter (i.e., having varying densities of opaque dots printed on a transparent substrate) providing a gradient of light attenuation and therefore a gradient of light sensitivity as a function of polar angle about the forward facing axis of the corresponding cluster.

As previously described, the distance to the light element is detected by an omni-directional light sensor and by inverse square law processing. In the preferred embodiment, the omni-directional light source comprises four mutually 90-degree divergent light sources each having a natural polar response typically limited to 0 to ±90 degrees of light as a function of polar angle about the axis of maximum intensity of the corresponding light source, and aggregately provides 4 pi steradians of non-uniform radiation of light, in which such light sources are in close proximity to and surrounded by a highly diffusive, preferably spherically shaped, filter to provide substantially 360-degrees of highly uniform fixed light intensity throughout such 4 pi steradians of radiation. Further in a preferred embodiment, the omni-directional light sensor comprises at least two divergently angled detectors, each such detector comprising at least one photo detector having a natural polar response typically limited to 0 to ±90 degrees of ambiguous (equal + and − angles) light sensitivity as a function of polar angle about the axis of maximum sensitivity of the corresponding photo detector, each detector receiving light from a highly diffusive and preferably hemi-spherically shaped filter in close proximity to the corresponding detector to provide at least 180-degrees of substantially equal light sensitivity as a function of polar angle about a forward facing axis of the corresponding detector.

For any photo detector comprised in any omni-directional or directional light sensor of the present invention, improved omni-directional or directional accuracy, as applicable, may be achieved through the inclusion of one of:

(1) an opaque plate having a front surface and thickness, such plate comprising a cylindrically-shaped aperture having a diameter and length, such aperture generally located at or near the center of the plate, wherein the plate is disposed on or adjacent to a photo detector and has a sufficiently large front surface to effectively shield all light that would otherwise impinge such photo detector excluding only a segment of such light passing through the aperture, wherein the thickness of the plate is by definition equal to the length of the aperture, the aperture length is preferably substantially greater than the aperture diameter, the aperture diameter is preferably substantially smaller than the photo detector, and wherein such plate, aperture and photo detector assembly provide an axis of maximum light sensitivity substantially coincident with the previously described axis of maximum sensitivity of the photo detector when utilized without the plate and aperture;

(2) the plate, aperture and photo detector assembly described in “(1)” above in which the photo detector is generally remotely located outside of the corresponding light detector, wherein such aperture is coupled to a first end of a fiber optic coupler, a second end of such fiber optic coupler is disposed within such light detector at the same location previously described for the photo detector when utilized without the plate and fiber optic coupler, and the second end of the fiber optic coupler is positioned and oriented within the light detector in such a manner as to provide an axis of maximum sensitivity substantially coincident with the previously described axis of maximum sensitivity ‘of the photo detector when utilized without the plate and fiber optic coupler; or

(3) the plate, fiber optic coupler and photo detector assembly described in “(2)” above in which the plate is not included and the first end of such fiber optic coupler couples directly to the photo detector.

Similarly, for any light emitter comprised in any omni-directional or directional light source or light element ‘of the present invention, improved omni-directional or directional accuracy, as applicable, may be achieved through the inclusion of at least one of such plate or fiber optic coupler in the manner described in “(1)”, “(2) or “(3)” above wherein the corresponding photo detector is substituted by a light source.

By normalizing each of the X-vector and Y-vector light detector intensities with reference to the omni-directional light detector intensity, the normalized X-vector and Y-vector intensities vary strictly in accordance with X-vector and Y-vector angles of incoming light, respectively, and not in part as a function of the overall intensity of incoming light in accordance with the intensity of or distance to the mobile light element disposed on the mobile light transmitter.

By virtue of the light element being disposed at one end of an armature held or worn by a player, the pitch and yaw attitude of such armature, or equivalent thereof affect Y-vector and X-vector positional data, respectively, of the light element as detected by the stationary receiver in the above-described manner. Thus, the position, motion, pitch and yaw of the mobile object are each detected, affect and interact with a video game of the video game system. In order to better capitalize on the above-described capability, pitch/yaw-intensive game formats may interpret small alternating X-vector and Y-vector positional changes, for example those created by short term variations in pitch or yaw movements of a player's wrist while holding the light transmitter, to indicate corresponding pitch and yaw movements of a displayed object or being; and, wherein X/Y position-intensive game formats may interpret large time-averaged X and Y positions of the hand-held light transmitter to indicate corresponding X/Y positions and movements of a displayed object or being.

The stationary receiver is located in close proximity to, substantially coplanar with, and preferably affixed to the top and at the left/right center of, the display monitor in order to optimally correlate images presented by the display monitor with corresponding position, motion and attitude of the mobile object relative to the position and orientation of the receiver. The perspectives and geometry of video game images presented by the monitor may be skewed, however, either automatically or by the player, to account for at least one of:

(a) a non-preferred placement or orientation of the light receiver (meaning not affixed to the top and at the left/right center of the monitor);

(b) the sensitivity to or magnitude of changes in such images, perspectives and geometry as a function of the magnitude of corresponding changes in the position, motion and attitude of the mobile object, such sensitivity optionally controlled by a user “movement magnifier” control or equivalent thereof;

(c) the sensitivity to or magnitude of changes in such images, perspectives and geometry as a direct function of detected distance between the stationary receiver and the mobile transmitter when appropriate for certain game perspectives and strategies, for example when presenting “close-up” avatar images wherein detected position changes in the mobile object must be normalized as a function of distance in order to appropriately scale the magnitude of their interactive affect upon such avatar; and

(d) the scale of a virtual space depicted by such video game images relative to the size of a game playing area in which the player intends to operate while interacting with a video game of the video game system, such scale optionally controlled by a user “game space” control or equivalent thereof.

In order to mitigate 50 to 60 Hz electrical power line operated ambient light source interference with the above light detectors, all light sources comprised in the mobile transmitter (and in some embodiments in the stationary receiver), are modulated by a modulation signal having a frequency that is substantially greater than the highest harmonic, component of significant amplitude in 50 to 60 Hz operated light sources that may contribute to such ambient light field, and, accordingly, such modulation signal is demodulated by all light sensors disposed in the stationary receiver (and in some embodiments in the mobile transmitter) thereby providing demodulated signals having amplitudes that are directly proportional to the amplitudes of the corresponding received modulated light. The above-described modulation and demodulation processes may be further utilized to transmit and receive game-playing data between the mobile transmitter and stationary receiver (and in some embodiments between the stationary receiver and the mobile transmitter). Generally, the use of infrared light sources and sensors further reduces susceptibility to ambient light interference.

In a first alternative embodiment, a camera having an infrared (IR) filter disposed about the entire lens or other receiving area of such camera, and specialized processing, operates with the mobile transmitter and substitutes the direction and distance detectors in the stationary receiver. Such camera is located in close proximity or affixed to the monitor and receives IR light emanating from the spherically shaped light element disposed at one end of the armature of the mobile transmitter, wherein the above described modulation of the light source(s) received by such camera may be one of eliminated or within the frequency range of substantially 0.1 p/s<Fm<1.0 p/s, where Fm=modulation frequency, p=scanned pixels, and s=seconds.

When light from the light element is within the frustrum of view of the camera, such light impinges a circular-shaped group of pixels of the camera, wherein, if there is no modulation of such light, a rapid rise time in output response of the camera occurs as the camera scans the first of such pixels within any given line, and a rapid fall time in output response of the camera occurs as the camera scans the last of such pixels within any such line, and wherein, if the above substantially frequency range of modulation is applied to such light, a corresponding demodulation frequency occurs within a time burst as the camera scans between the first and last such pixels within any such line. Since the circular shaped pixel group typically comprises a multiplicity of adjacent lines, a corresponding multiplicity of the above rapid rise and fall times occurs in a contiguous manner if there is no modulation of such light, and a corresponding multiplicity of such demodulated frequency bursts occurs in a contiguous manner if such modulation is applied to such light. The time duration between (a) such rise and fall times or (b) such demodulated frequency bursts (as applicable) for any scanned line, when multiplied by the camera horizontal scan rate, indicates the width of such pixel group across such line; the maximum one of such time durations occurring in a contiguous manner, which multiplied by the camera horizontal scan rate, indicates the width of the entire such pixel group; and, the aggregate of such time durations occurring in a contiguous manner, when multiplied by the camera vertical scan rate, indicates the height of the entire such pixel group. The center and size of the pixel group may thereby be easily determined and, in turn, the X-Y vectors of and distance to the incoming light from the spherically shaped mobile light element may also be computed. The intensity of camera output response for pixels with the pixel group varies with the intensity of pixels within the group and may also be ‘utilized to determine the distance to such light element. Since the light element is disposed at one end of an armature comprised in the mobile transmitter, and since, as previously explained, changes in the pitch, yaw and roll attitude of the mobile transmitter thereby confer corresponding changes in detected X-Y position of the light element, the above single camera of the present invention detects the X-Y directional vector and distance to, and the pitch, yaw and roll attitude of, the mobile transmitter with respect to such camera and the stationary receiver.

Further relating to such the above alternative embodiment, such camera may view and detect, through additional machine vision processing, differing characteristics located about the surface of the light element of the mobile transmitter, such differing characteristics may consist of, but are not limited to, at least one of (a) geometric patterns of light, (b) opaque markings or patterns overlaying such light, (b) light intensity, (c) sequences of light intensity, (d) colors of light, or (d) polarizations of light, whereby at least one of the pitch, yaw and roll attitude of the light element of the mobile transmitter is detected by such camera.

In a second alternative embodiment, the position of the modulated light emitted by the omni-directional light element disposed at one end of the armature is detected, demodulated and triangulated by at least three detectors, such detectors comprising at least one of the above distance sensor and optionally at least one of the above directional vector sensor, whereby such detectors may be one of (a) collectively comprised in a common enclosure located in close proximity or affixed to the monitor, (b) individually comprised in at least two enclosures located in specific spatial relationship to one another and in close proximity or affixed to the monitor, (c) comprised in at least two enclosures that may be located at any practical position in view by and forward of (toward the monitor) the player, wherein such enclosures may be separated from one another by any practical distance, (i.e., two thin vertical towers each comprising a top and a bottom modulated light source), wherein the mobile light transmitter calibrates, either periodically or by user-instruction, to the distances between such mobile transmitter and each such light source, and optionally between such enclosures, wherein such calibration may utilize calibration dedicated images and promptings on the monitor.

In other alternative embodiments:

(a) the mobile omni-directional light transmitter may be substituted by a mobile omni-directional light receiver, and the stationary light receiver may be substituted by a stationary light transmitter, wherein all light sources in the previously described mobile light transmitter are substituted by light sensors, and wherein all light sensors in the previously described stationary receiver are substituted by light sources;

(b) the mobile omni-directional light element may be substituted by a mobile omni-directional retro-reflective light element, wherein inverse square law applies to incoming light to, but substantially not reflected light from, such retro-reflective light element;

(c) omni-directional light sources may be substituted by omni-directional ultrasonic, infrared (IR) or radio frequency (RF) sources;

(d) directional light sources may be substituted by directional ultrasonic, IR or RF sources;

(e) omni-directional light sensors may be substituted by omni-directional ultrasonic, IR or RF sensors;

(f) directional light sources may be substituted by directional ultrasonic, IR or RF sensors; or

(g) a unilateral or bilateral radio link between any one of the mobile and stationary transmitter/receiver or previously-described enclosures, serves to at least one of: (i) determine distances between any such devices through inverse square law or time-of-flight processing; or (ii) communicate game playing data between any such devices.

In further embodiments:

(1) multiple mobile objects and light transmitters employ different above-described modulation frequencies, thereby enabling multiple transmitters to operate with single or multiple light receivers;

(2) at least one of the X-vector or Y-vector light sensors may be substituted by at least one angularly scanned X-vector or angularly scanned Y-vector light sensor, respectively;

(3) at least one of the X-vector or Y-vector light sources may be substituted by at least one angularly scanned X-vector or angularly scanned Y-vector light sources, respectively;

(4) at least one beam splitter disposed between at least one of the X-vector sensor, Y-vector sensor and omni-directional sensor as a means to optically co-locate and thereby optimally align the axes of the above sensors;

(5) ultrasound employed to determine the distance between the mobile transmitter and stationary receiver and thereby substituting the distance detector, wherein ultrasound transmission and reception between the mobile transmitter and stationary receiver, respectively, are time-referenced at the speed of light, via light or radio, between the mobile transmitter to the stationary receiver;

(6) at least one gravity direction sensor is comprised in the mobile transmitter as a means to provide or assist in the derivation of the pitch and other kinetic movements of the mobile transmitter;

(7) video game system remote controlled objects (RCOs) within the game playing space, other than the mobile transmitter, wherein at least one of the position or attitude of such RCO objects is detected in accordance with the principles of the video game system and provide such game-interactivity functions as, but not limited to, proximity detection, lighting effects, sound effects, speech recognition, goal and safety zones, and point acquisition zones; and,

(8) Global Positioning Satellite (GPS) detection, particularly at the micro circuit level, comprised in the mobile transmitter and/or stationary detector, as means to provide or assist in the derivation of at least one of the position, particularly changes in the position and attitude of the mobile transmitter and/or stationary receiver.

Although a wide variety of video game interactive modalities are made possible by the video game system of the present invention, the following specific such interactive modalities are unique within their own right:

1. X/Y/Z positional data of a mobile object affects and interacts with, in a positionally stable, non-drifting and repeatable manner, objects, environments, perspectives, etc., displayed by a video game system, in such a manner as to substantially retain, overtime and without need for reference position resetting, such positional factors in a video game of the video game system.

2. Pitch/yaw attitude data of a mobile object held or worn by a player, which attitude may be detected as changes in X/Y/Z positional data when such mobile object is disposed at one end of an armature held or worn by a player, affect and interact with the attitude of a corresponding displayed video game object, being, environmental factors, view perspectives, etc., wherein short duration changes or oscillations in such data may be interpreted by the video game system to confer corresponding attitudes of displayed objects, scenes, perspectives, etc., and in which long duration or time-averaged such data may be interpreted by the video game system to confer corresponding positions of a displayed objects, beings, perspectives, etc., thereby enabling differentiation between attitude and position movements of a mobile object or armature thereof. The scale of the above video game displayed attitude and position changes are preferably user-controllable.

3. Video game system displayed virtual spaces, and positions of virtual objects, synthespians and avatars within such virtual space, each substantially correlated, preferably by user-adjustable scale, to corresponding actual game playing spaces, interactive positions of imaginary objects, beings, perspectives, etc., and player positions within such actual spaces, such as to enable the player and actual game playing environment to become spatially and interactively analogous in a realistic manner.

4. Simultaneous or sequential video game interactivity with multiple players, each such player holding or wearing a corresponding remote mobile object operating on different modulation frequencies so as to enable simultaneous or sequential multiple player interactivity.

5. Video game interactivity with remote controlled objects (RCOs), wherein at least one of the position or attitude of such RCOs are detected in accordance with the principles of the present invention and provide augmented game interactive functions that may include, but are not limited to, player proximity detection, lighting and sound effects, speech synthesis and recognition, and goal/safety/score zones.

Numerous additional applications exist for the mobile object position, motion and attitude detection apparatus and processes of the present invention, including, but not limited to, the following, wherein each indicated device incorporates or is affixed to at least one such mobile object:
Simplified and more cost effective hardware and software machine vision processing relative to conventional machine vision processing, such simplified processing dedicated primarily to the object position and motion detection.
3D mice/gloves for use with computers, 2D displays for 2D and/or 3D graphic imagery, 3D spatial/stereoscopic displays, etc., each applies to video games, internet activity, virtual reality (VR), educational and other interactive systems.
Moving and non-moving object proximity and position detector modules for cinematography motion capture, robotic navigation, collision avoidance, artificial vision, object manipulation, and other applications within and outside such fields.
Remote control of vehicles or other mobile objects, including but not limited to robotic or toy objects, wherein the directional vector of the corresponding remote controller relative to, and detected by, such objects enable remote control directional instructions, for example by means of a joy stick, to remain directionally analogous to the movement of such objects irrespective of the objects' orientation or direction of travel relative to such controller.

Other objects and features of the present invention will become apparent from the following descriptions considered in conjunction with the accompanying drawings. It is to be understood that the drawings are not necessarily drawn proportionately or in scale and, unless otherwise indicated, are merely intended to conceptually illustrate the structures, processes and functions described herein. Designated letters and numbers in each of the following drawings correspond to like designated letters and numbers in the remaining drawings.

### BRIEF DESCRIPTIONS OF THE DRAWINGS

In the drawings wherein like references numerals denote similar elements throughout the views;

FIG. 1 is a schematic diagram of the mobile modulated light transmitter of the preferred embodiment of the present invention.

FIG. 2 is a schematic diagram of the stationary light receiver of the’ preferred embodiment of the present invention.

FIG. 3 is a block diagram of a photo detector, opaque plate and fiber optic coupler assembly comprised in embodiments of the present invention.

FIG. 4a is a block diagram, from the top view, of the light direction and distance detector comprised in the mobile light transmitter and of the stationary light receiver of the preferred embodiment of the present invention.

FIG. 4b is a block diagram, from the front view, of the light direction and distance detector comprised in the mobile light transmitter and of the stationary light receiver of the preferred embodiment of the present invention.

FIG. 4c is a block diagram, from the side view, of the light direction and distance detector comprised in the mobile light transmitter and of the stationary light receiver of the preferred embodiment of the present invention.

### DETAILED DESCRIPTION

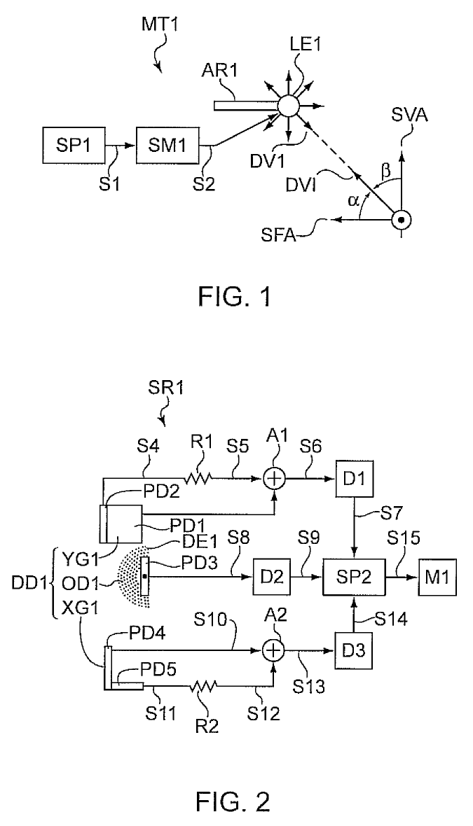

FIG. 1 is a schematic diagram of mobile light transmitter MT1 of the preferred embodiment of the present invention, in which signal processor SP1 provides game playing and modulation data S1 to signal modulator SM1. SM1 provides modulated signal S2 to omni-directional light element LE1 disposed at one end of armature AR1. LE1 uniformly radiates light in all directions throughout substantially 4 pi steradians of curvature, as indicated by arrows surrounding LE1, including directional vector DV1.

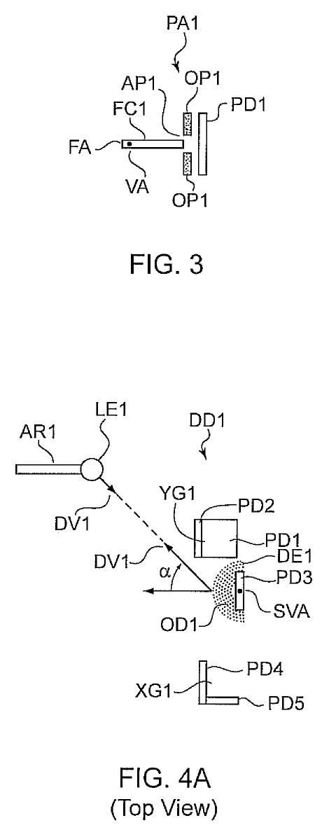

FIG. 2 is a schematic diagram of stationary light receiver SR1 of a preferred embodiment of the present invention, in which light direction and distance detector DD1 determines directional vector DV1, as defined by X-vector angle a relative to the stationary forward axis (SFA) of DD1 and by Y-vector angle P relative to the stationary vertical axis (SVA) of DD1 (for simplification X-vector and Y-vector angles are depicted in a 2-dimensional rather than a 3-dimensional drawing), and distance to light element LE1 (shown in FIG. 1). DD1 comprises Y-vector gradient detector YG1, omni-directional detector OD1, and X-vector gradient detector XG1. Y-vector gradient detector YG1 comprises a cluster of two photo detectors consisting of upper Y-axis photo detector PD1 and lower Y-axis photo detector PD2. PD1 provides upper Y-axis signal S3 applied, in an un-attenuated manner, to a first input of adder A1. PD2 provides lower Y-axis signal S4 applied to resistor R1 (symbolically representing an attenuation). R1 provides attenuated lower Y-axis signal S5 applied to a second input of adder A1. A1 provides Y-vector signal S6 to demodulator D1, which in turn provides demodulated Y-vector signal S7 having an amplitude level that is proportional to Y-vector angle β and the intensity of incoming light along vector DV1. Omni-directional detector OD1 comprises omni-directional photo detector PD3 and hemispherically shaped diffusion element disposed about PD3. PD3 provides omni-directional signal S8 to demodulator D2, which in turn provides demodulated omni-directional signal S9 having an amplitude level that is proportional only to the intensity of incoming light along vector DV1. X-vector gradient detector XG1 comprises a cluster of two photo detectors consisting of left X-axis photo detector PD4 and right Y-axis photo detector PD5. PD4 provides left X-axis signal S10 applied, in an un-attenuated manner, to a first input of adder A2. PD5 provides right Y-axis signal S11 applied to resistor R2 (symbolically representing an attenuation). R2 provides attenuated right Y-axis signal S12 applied to a second input of adder A2. A2 provides Y-vector signal S13 to demodulator D3, which in turn provides demodulated omni-directional signal S14 having an amplitude level that is proportional to X-vector angle a and the intensity of incoming light along vector DV1.

Detector DDI has a stationary forward axis SFA of maximum sensitivity and a stationary vertical axis SVA of maximum sensitivity (both such axes shown on detector DD1 comprising PD3). Signal process SP2 divides or otherwise normalizes demodulated Y-vector signal S7 by demodulated omni-directional signal S4, thereby determining an incoming (along vector DV1) light intensity normalized value for the Y-vector of such incoming light and similarly, SP2 divides or otherwise normalized demodulated X-vector signal S14 by demodulated omni-directional signal S4, thereby determining an incoming light intensity normalized value for the X-vector of such incoming light. SP2 conducts other game operation function's as may at any time be provided to it by signal S9 or through other input means, and provides video output signal S15 to video monitor M1.

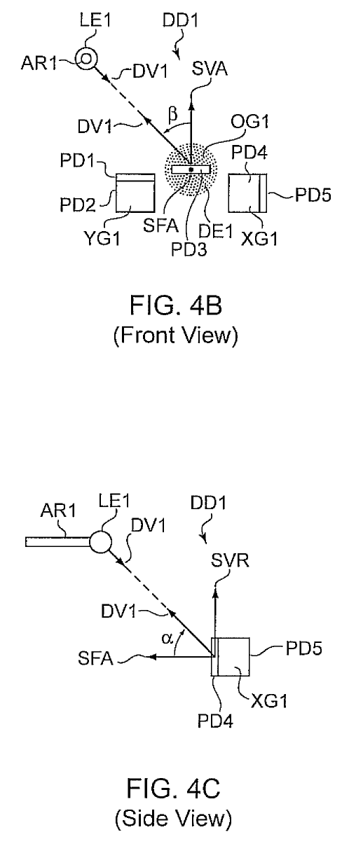

FIG. 3 is a block diagram of a photo detector, opaque plate and fiber optic coupler assembly PA1 comprised in multiple embodiments of the present invention, in which incoming light is received at a first end of fiber optic coupler FOC1 such first end having a forward axis FA and a vertical axis VA. A second end of FOC1 couples to circular aperture AP1 in opaque plate OP1. OP1 is affixed and transfers such light to photo detector PDI.

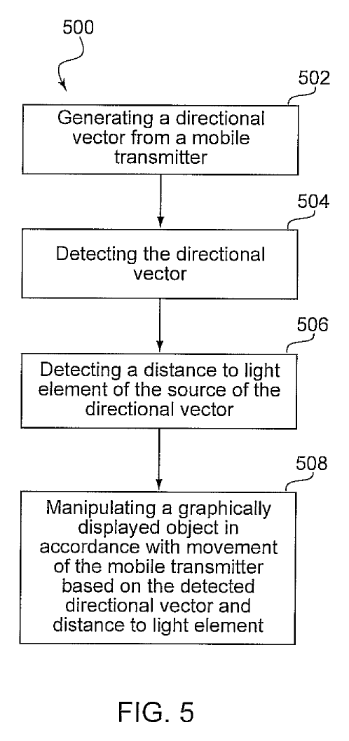

FIG. 4a is a block diagram, from the top view, of light direction and distance detector DD1 comprised in the mobile light transmitter and of the stationary light receiver of the preferred embodiment of the present invention, in which light element DE1 is disposed at one end of armature ARI and radiates light along directional vector DV1. Detector DDI determines directional vector DV1, as defined by X-vector angle a relative to the stationary forward axis (SFA) of DD1. In the present top view, only the X-vector is considered and the stationary vertical axis (SVA) of DD1 is seen as a dot at the center of DD1 and photo detector PD3.

Detector DD1 comprises Y-vector gradient detector YG1, omni-directional detector OD1, and X-vector gradient detector XG1. Y-vector gradient detector YG1 comprises a cluster of two photo detectors consisting of upper Y-axis photo detector PD1 and lower Y-axis photo detector PD2. Omni-directional detector OD1 comprises omni-directional photo detector PD3 and hemispherically shaped diffusion element disposed about PD3. X-vector gradient detector XG1 comprises a cluster of two photo detectors consisting of left X-axis photo detector PD4 and right Y-axis photo detector PD5.

FIG. 4b is a block diagram, from the front view, of light direction and distance detector DD1 comprised in the mobile light transmitter and of the stationary light receiver of the preferred embodiment of the present invention, in which light element DE1 is disposed at one end of armature AR1 and radiates light along directional vector DV1. Detector DD1 determines directional vector DV1, as defined by Y-vector angle β relative to the stationary forward axis (SFA) of DD1. In the present front view, only the Y-vector is considered and the stationary vertical axis (SVA) of DD1 is seen as a vertical line at the center of DD1 and photo detector PD3. Detector DD1 comprises Y-vector gradient detector YG1, omni-directional detector ODI, and X-vector gradient detector XGI. Y-vector gradient detector YG1 comprises a cluster of two photo detectors consisting of upper Y-axis photo detector PD1 and lower Y-axis photo detector PD2. Omni-directional detector OD1 comprises omni-directional photo detector PD3 and hemispherically shaped diffusion element disposed about PD3. X-vector gradient detector XG1 comprises a cluster of two photo detectors consisting of left X-axis photo detector PD4 and right Y-axis photo detector PD5.

FIG. 4c is a block diagram, from the side view, of the light direction and distance detector comprised in the mobile light transmitter and of the stationary light receiver of the preferred embodiment of the present invention, in which light element DE1 is disposed at one end of armature AR1 and radiates light along directional vector DV1.

Detector DD1 determines directional vector DV1, as defined by X-vector angle a relative to the stationary forward axis (SFA) of DD1. In the present side view, only the X-vector is considered and the stationary vertical axis (SVA) of DD1 is seen as a vertical line at the center of DD1. Detector DDI comprises Y-vector gradient detector YGI, omni-directional detector OD1, and X-vector gradient detector XG1, although in the present side view only XG1 is seen and, for clarity, the diffusion element associated with the omni-directional detector is not shown. X-vector gradient detector XG1 comprises a cluster of two photo detectors consisting of left X-axis photo detector PD4 and right Y-axis photo detector PD5.

What is claimed is:

1. An apparatus for detecting a mobile object position, motion and attitude, the apparatus comprising:
a mobile transmitter generating a directional vector by uniformly emitting a fixed intensity of light throughout a space subtending substantially 4 pi Steradians of curvature; and
a stationary receiver configured to detect the directional vector and determine the distance to the mobile transmitter, each with respect to the receiver.

2. The apparatus according to claim 1, wherein said mobile transmitter further comprises an omni-directional light element.

3. The apparatus according to claim 1, wherein the stationary receiver further comprises:
a directional vector detector; and
a distance to light detector.

4. The apparatus according to claim 3, wherein the directional vector detector comprises a photo detector exhibiting 0 to +90 degrees of non-ambiguous light sensitivity as a function of angle relative to the axis of maximum sensitivity of such detector.

5. The apparatus according to claim 3, wherein the directional vector detector comprises two clusters of photo detectors, each cluster having axes of maximum sensitivity that are orthogonal to one another and wherein each cluster exhibits 0-+180 degrees of non-ambiguous light sensitivity as a function of angle relative to the corresponding cluster axis of maximum sensitivity.

6. The apparatus according to claim 3, wherein the directional vector detector comprises two photo detectors having axes of maximum sensitivity that are orthogonal to one another.

7. The apparatus according to claim 3, wherein the distance to light detector comprises an omni-directional light sensor.

8. The apparatus according to claim 7, wherein the omni-directional light sensor comprises four mutually 90-degree divergent light sources each having a natural polar response limited to 0 to ±90 degrees of light as a function of polar angle about an axes of maximum intensity of the corresponding light source.

9. The apparatus according to claim 2, wherein the omni-directional light sensor further comprises an opaque plate having a front surface, a thickness and a cylindrically shaped aperture having a diameter and a length, wherein the thickness of the plate is equal to the length of the aperture.

10. The apparatus according to claim 7, wherein the omni-directional light sensor further comprises an opaque plate having a front surface, a thickness and a cylindrically shaped aperture having a diameter and a length, wherein the thickness of the plate is equal to the length of the aperture.

11. A method or detecting position, motion and attitude of a mobile object, the method comprising the steps of:
providing a transmitter in the mobile object;
generating a directional vector during movement of the mobile object;
detecting the generated directional vector;
detecting a distance to light element between the mobile transmitter and a receiver; and
manipulating a graphically displayed object in accordance with the movement of the transmitter in the mobile object based on the detected directional vector and the distance to light element.

12. The method according to claim 11, wherein said generating further comprises emitting, by the transmitter, a fixed intensity of light throughout space by subtending substantially 4 pi Steradians of curvature.

13. The method according to claim 11, wherein said detecting of the directional vector further comprises:
providing an omni-directional light sensor in the form of a photo detector in a receiver, said photo detector exhibiting a 0 to +90 degrees of non-ambiguous light sensitivity as a function of angle relative to the axis of maximum sensitivity of said photo detector.

14. The method according to claim 11, wherein said detecting of the directional vector further comprises:
providing an omni-directional light sensor in the form of two clusters of photo detectors in a receiver, each cluster having axes of maximum sensitivity that are orthogonal to one another and wherein each cluster exhibits 0 to +180 degrees of non-ambiguous light sensitivity as a function of angle relative to the corresponding cluster axes of maximum sensitivity.

15. The method according to claim 11, wherein said detecting of the distance to light element comprises:
providing an omni-directional light sensor having four mutually 90-degree divergent light sources each having a natural polar response limited to 0 to ±90 degrees of light as a function of polar angle about an axes of maximum intensity of the corresponding light source.
